(19) United States
(12) Patent Application Publication
(10) Pub. No.: US 2007/0024533 A1
(43) Pub. Date: Feb. 1, 2007

(54) Plasma display and driving method thereof

(76) Inventor: Seung-Hun Chae, Chunan-si (KR)

Correspondence Address: CHRISTIE, PARKER & HALE, LLP, PO BOX 7068, PASADENA, CA, 91109-7068, US

(21) Appl. No.: 11/489,867

(22) Filed: Jul. 19, 2006

(30) Foreign Application Priority Data
Jul. 27, 2005 (KR) 10-2005-0068332

(51) Int. Cl. G09G 3/28

(52) U.S. Cl. 345/63

(57) ABSTRACT

In a plasma display device, sustain electrodes are divided into first and second groups. A frame period is divided into subfields. In one subfield, discharge cells of the first group are initialized during a first reset period and addressed during a first address period and cells of the second group are initialized during a second reset period and addressed during a second address period. During a subsequent subfield, the cells of the second group are reset and addressed before the cells of the first group. The first reset period is an auxiliary reset period for initializing cells having been sustain-discharged in a previous subfield. The second reset period is a main reset period that may be used for initializing cells that were not sustain-discharged immediately prior to the main reset period. A final voltage is maintained longer during auxiliary reset than main reset.

### CROSS-REFERENCE TO RELATED APPLICATION

This application claims priority to and the benefit of Korean Patent Application No. 10-2005-0068332 filed in the Korean Intellectual Property Office on Jul. 27, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display device that uses plasma generated by a process of electric discharge in gas to display characters or images. It includes a plurality of discharge cells arranged in a matrix pattern.

One frame of the plasma display device is divided into a plurality of subfields each having a corresponding weight, and each including a reset period, an address period, and a sustain period. The reset period is for initializing the status of each discharge cell to facilitate a subsequent addressing operation on the discharge cell. The address period is for selecting turn-on/turn-off cells (i.e., cells to be turned on or off). The sustain period is for causing the cells to either continue discharge for displaying an image on the addressed cells or remain inactive.

FIG. 1 shows a driving waveform diagram of a conventional plasma display device.

As shown in FIG. 1, during the address period, a voltage VscL is sequentially applied to scan electrodes Y, and a turn-on discharge cell is selected by applying an address voltage Va to an address electrode A passing through the turn-on discharge cell to be selected among discharge cells formed by the scan electrodes to which the voltage VscL is applied. During each address period, an address operation is sequentially performed in all the discharge cells being addressed during that address period. Therefore, the discharge cells, addressed later during the address period may lack sufficient priming particles for a proper discharge. As a result, address discharge may not be appropriately generated in the discharge cells addressed later or toward the end of the address period.

### SUMMARY OF THE INVENTION

The present invention provides a plasma display device for stably performing an address discharge, and a driving method for performing a stable address discharge.

An exemplary driving method according to an embodiment of the present invention drives a plasma display device during frames that are each divided into a plurality of subfields. The plasma display device has a plurality of first electrodes, a plurality of second electrodes, and a plurality of third electrodes crossing a common direction of the first and second electrodes. In the exemplary driving method, the plurality of first electrodes are divided into a plurality of groups including first and second group of first electrodes. The plurality of subfields are divided into a plurality of groups including first and second groups. In a subfield of the first group, first group discharge cells are initialized during a first reset period, a turn-on discharge cell is selected among the first group discharge cells during a first address period, second group discharge cells are initialized during a second reset period, a turn-on discharge cell is selected among the second group discharge cells during a second address period, and the selected first and second group discharge cells are sustain-discharged during a sustain period. In addition, final voltages of the first and second reset periods are maintained at a constant voltage for different durations of time. The first group discharge cells correspond to the first group of first electrodes and the second group discharge cells correspond to the second group of first electrodes.

One of the first and second reset periods is an auxiliary reset period for gradually decreasing a voltage at the second electrode from a first voltage to a second voltage, and the other is a main reset period for gradually decreasing the voltage at the second electrode from a fifth voltage to a sixth voltage after decreasing the voltage at the second electrode from a third voltage to a fourth voltage. The auxiliary reset period includes only a falling period. The main reset period includes both rising and falling periods.

In addition, in a subfield of the second group of subfields, the second group discharge cells are initialized during a third reset period, the turn-on discharge cell is selected from among the second group discharge cells during a third address period, the first group discharge cells are initialized during a fourth reset period, the turn-on discharge cell is selected from among the first group discharge cells during a fourth address period, the selected first and second group discharge cells are sustain-discharged during the sustain period. The final voltage during the third reset period and the fourth reset period is maintained at a substantially constant final value for durations of time that are different from each other.

In addition, a seventh voltage is applied to the third electrode and the voltage at the second electrode is gradually decreased from an eighth voltage to a ninth voltage after the first address period or the second address period subsequent to the first reset period. A difference between the seventh voltage and the ninth voltage is greater than a difference between voltages applied to the third and second electrodes when the second voltage is applied to the second electrode during the first reset period.

In the driving method of the embodiments of the invention, a first group of discharge cells are reset and addressed during a first reset period immediately followed by a first address period of one subfield and a second group of discharge cells are reset and addressed during a second reset period immediately followed by a second address period of the same subfield. During a subsequent subfield, the order of reset and addressing is reversed and the second group of discharge cells are reset and addressed before the first group. The two reset periods within a subfield are different. The first reset period is capable of initializing only cells that have been sustain discharged immediately prior to the reset period. The second reset period of each subfield is capable of initializing any type of cell including discharge cells that may have been discharged not immediately prior to the second reset period and may have lost some of the wall charges developed during a sustain period preceding the subfield.

An exemplary plasma display device according to an embodiment of the present invention includes a plasma display panel (PDP), a controller, and a driving circuit. The plasma display panel includes a plurality of first electrodes, a plurality of second electrodes, and a plurality of third electrodes crossing the first and second electrodes. The controller drives the plurality of first electrodes as a plurality of groups including first and second groups of first electrodes, and drives the plurality of first electrodes during a plurality of subfields having first and second groups of subfields divided from a frame. The driving circuit initializes first group discharge cells during a first reset period, address discharges the first group discharge cells during a first address period, initializes second group discharge cells during a second reset period, and address discharges the second group discharge cells during a second address period, in a subfield of the first group.

In addition, the driving circuit applies final voltages during the first and second reset periods such that times for maintaining the final voltages during the first and second reset periods are different from each other.

### BRIEF DESCRIPTION OF THE DRAWINGS

FIG. 1 shows a driving waveform diagram of a conventional plasma display device.

FIG. 2 shows a schematic diagram representing a plasma display device according to an exemplary embodiment of the present invention.

FIG. 3, FIG. 4, and FIG. 5 show driving waveforms of the plasma display device according to respectively first, second, and third exemplary embodiments of the present invention.

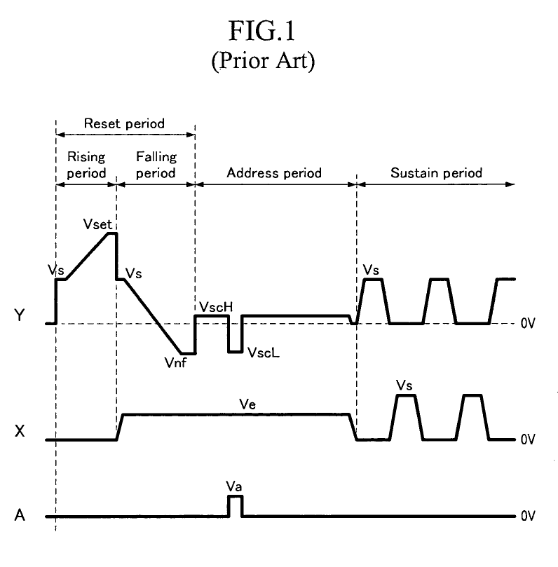

### DETAILED DESCRIPTION OF THE EMBODIMENTS

Wall charges mentioned in the following description mean charges formed and accumulated on a wall (e.g., a dielectric layer) close to an electrode of a discharge cell. A wall charge will be described as being “formed” or “accumulated” on the electrode, although the wall charges do not actually touch the electrodes. Further, a wall voltage means a potential difference between the walls of the electrodes of the discharge cell created by the wall charges on the electrodes.

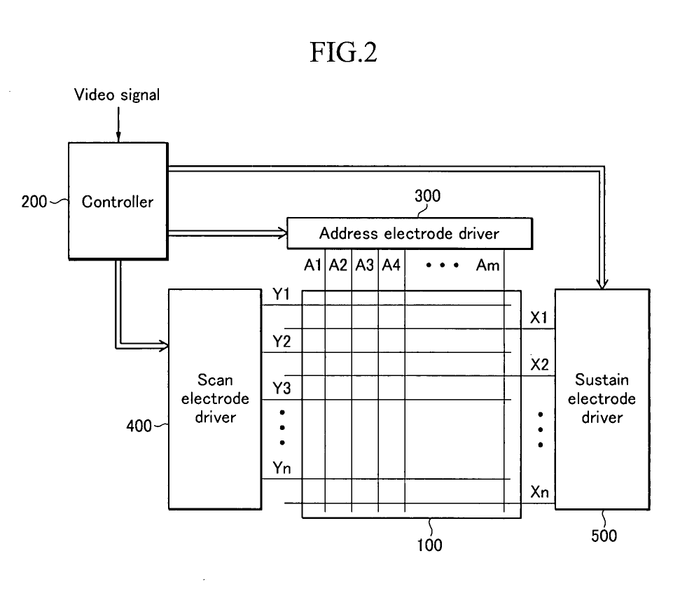

FIG. 2 shows a schematic diagram representing the plasma display device according to one exemplary embodiment of the present invention. The plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain and scan electrodes X1 to Xn and Y1 to Yn extending in a row direction. The sustain and scan electrodes are arranged in pairs of X1Y1 . . . XnYn. The sustain electrodes X1 to Xn are formed to respectively correspond to the scan electrodes Y1 to Yn, and ends of the sustain electrodes X1 to Xn are connected in common. In addition, the PDP 100 includes one substrate (not shown) having the sustain and scan electrodes X1 to Xn and Y1 to Yn, and another substrate having the address electrodes A1 to Am. The two substrates are arranged to face each other with a discharge space between them so that a common direction of the scan electrodes Y1 to Yn and the sustain electrodes X1 to Xn may cross a direction of the address electrodes A1 to Am. A discharge space formed at an area where the address electrodes A1 to Am cross over or under the sustain and scan electrodes X1 to Xn and Y1 to Yn forms a discharge cell. The PDP 100 shows only one exemplary embodiment, and other panels to which subsequent driving waveforms are applicable can also be included in the display device of the present invention. The scan, sustain, and address electrodes are hereinafter, respectively referred to as Y, X, and A electrodes.

The controller 200 receives an external video signal and outputs an address electrode driving control signal, a sustain electrode driving control signal, and a scan electrode driving control signal. In addition, the controller 200 divides a frame into a plurality of subfields, and divides the plurality of sustain electrodes X into a plurality of groups and drives them. Each subfield has a reset period, an address period, and a sustain period.

After receiving the address driving control signal from the controller 200, the address electrode driver 300 applies a display data signal for selecting discharge cells to be displayed to the respective address electrodes A1 to Am.

The scan electrode driver 400 applies a driving voltage to the scan electrodes Y after receiving the scan electrode driving control signal from the controller 200, and the sustain electrode driver 500 applies the driving voltage to the sustain electrodes X after receiving the sustain electrode driving control signal from the controller 200.

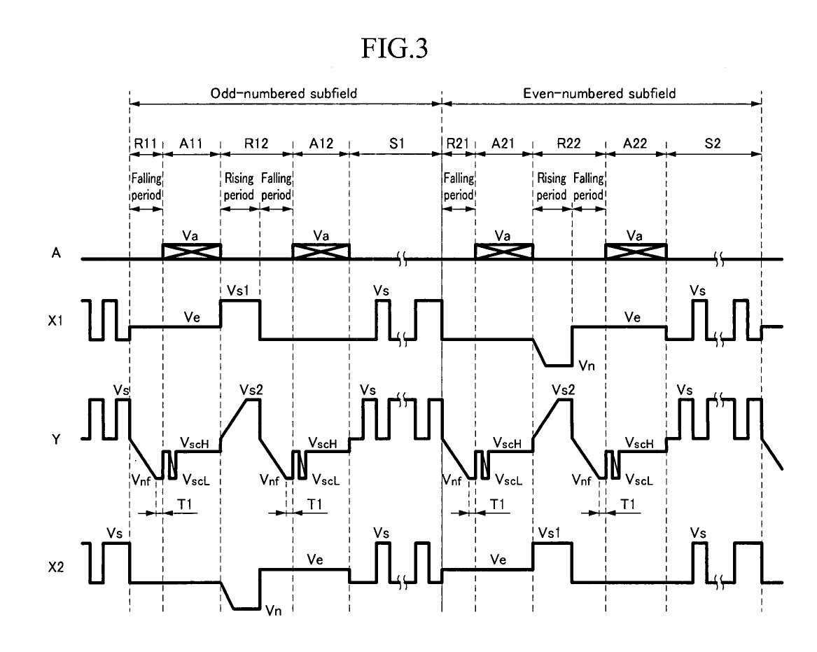

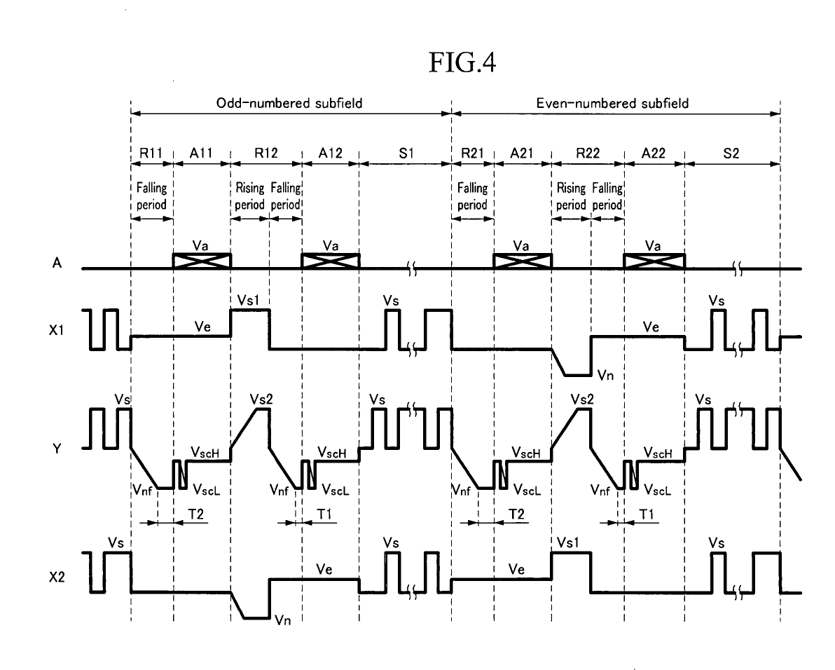

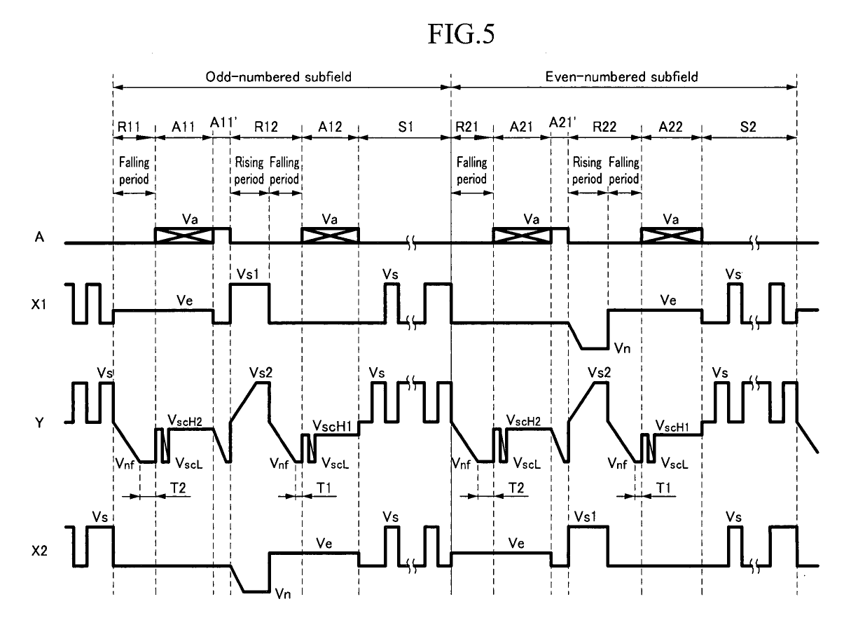

Driving waveforms of the plasma display device according to a first exemplary embodiment of the present invention will be described with reference to FIG. 3. For convenience of description, a driving waveform applied to the scan, sustain, and address electrodes Y, X, A forming one cell will be described.

FIG. 3 shows a diagram representing driving waveforms according to the first exemplary embodiment of the present invention for the plasma display device of the present invention.

The driving method according to the first exemplary embodiment of the present invention divides the X electrodes into a plurality of groups of X electrodes. In FIG. 3, the X electrodes are divided into two groups, a first group including odd-numbered X electrodes and a second group including even-numbered X electrodes. Discharge cells formed by the X electrodes of the first group will be referred to as first group discharge cells, and discharge cells formed by the X electrodes of the second group will be referred to as second group discharge cells.

As described above, in one subfield, the address operation for the second group discharge cells that are reset by the main reset may be performed after the address operation for the first group discharge cells reset by the auxiliary reset. On the other hand, in a conventional driving method, the address operation is sequentially performed for all of the discharge cells after one reset operation. Therefore, when the discharge cells are addressed in groups, the time required for performing the address operation from a first discharge cell to the last discharge cell of each group after the reset operation is performed for that group, may be reduced by half compared to a conventional driving method. Accordingly, the address discharge may be stably generated.

While in the subfields shown in FIG. 3, the auxiliary reset is performed before the main reset, the order may be varied in other exemplary embodiments. For example, the main reset may be performed before the auxiliary reset. Alternatively, only one of the auxiliary and main resets may be performed in each subfield. The auxiliary reset causes a reset discharge when the sustain discharge was generated in the previous subfield but does not cause the reset discharge if the sustain discharge was not generated in the previous subfield. Also, in FIG. 3, the sustain discharge of the previous subfield occurs immediately before the auxiliary reset period. The time interval between the end of the sustain discharge in the previous subfield and the beginning of the auxiliary reset may be increased when the auxiliary reset is performed after the main reset. In this case, the auxiliary reset may generate inappropriate wall charges because priming particles may be eliminated during the long interval between the sustain discharge and the auxiliary reset. Also, the duration of the reset operation may be increased when only the main reset is performed. Therefore according to the first exemplary embodiment of the present invention, in each subfield, the auxiliary reset is performed before the main reset.

The subfields of a frame may be odd-numbered subfields or even-numbered subfields. First, the driving waveform applied to an odd-numbered subfield will be described.

As shown in FIG. 3, in a sustain period preceding the odd-numbered subfield, a last sustain discharge is generated between the Y electrode and the X electrode X1 of the first group when a voltage Vs is applied to the Y electrode and a reference voltage (0V in FIG. 3) is applied to the X electrode X1. The sustain discharge is not generated between the Y electrode and the X electrode X2 of the second group because the X electrode X2 of the second group is also biased at the voltage Vs. The last sustain discharge would be generated between the Y electrode and the X electrode X2 if the voltage Vs were applied to the X electrode X2 and the reference voltage were applied to the Y electrode.

During a failing period of a reset period R11, a voltage at the Y electrode is gradually decreased to a voltage Vnf after a last sustain pulse is applied to the Y electrode during the sustain period of the previous subfield. During this time, the reference voltage is applied to the X electrode X2 of the second group, and the X electrode X1 of the first group is biased at a voltage Ve. Then, a weak reset discharge is generated between the Y electrode and the X electrode X1 and between the Y electrode and the A electrode while the voltage at the Y electrode is being decreased. As a result, negative (−) wall charges formed on the Y electrode and positive (+) wall charges formed on the X electrode X1 and the A electrode, during the preceding sustain period, are eliminated.

Accordingly, because a weak discharge is generated when a level of a voltage at an electrode is gradually changed as shown in FIG. 3, wall charges are formed so that a sum of the external voltage and the wall voltage of a cell may be maintained at a discharge firing voltage state.

In general, a voltage of (Ve-Vnf) is set close to a discharge firing voltage between the Y and X electrodes. As stated above, the sum of the external voltage and the wall voltage of a cell is maintained near the discharge firing voltage. If the external voltage of (Ve-Vnf) is already at the discharge firing voltage, then the wall voltage between the Y and X electrodes would be approximately 0V. When the wall voltage between the Y and X electrodes is nearly 0V, then, misfiring during a succeeding sustain period may be prevented in a cell where the address discharge was not generated in the address period.

In addition, negative (−) wall charges are formed on the X electrode X2 of the second group and positive (+) wall charges are formed on the Y electrode after the sustain period preceding the odd-numbered subfield. Then, during the auxiliary reset period R11, when the voltage at the Y electrode is decreased to the voltage Vnf, positive (+) wall charges are formed on the Y electrode and negative (−) wall charges are formed on the X electrode X2. As a result, a potential difference between the Y electrode and the X electrode X2 of the second group is reduced. Accordingly, the reset discharge is not generated between the Y electrode and the X electrode X2 of the second group during the auxiliary reset period R11.

Subsequently, to select a discharge cell in an address period A11, a scan pulse having the voltage VscL is sequentially applied to the Y electrodes, and the Y electrodes to which the voltage VscL is not applied are biased at a voltage VscH. In addition, an address pulse having a voltage Va is applied to an A electrode passing through the discharge cell to be selected among the plurality of discharge cells formed by the Y electrode to which the voltage VscL is applied, and the A electrodes which are not selected are biased at the reference voltage.

Subsequently, positive (+) wall charges are formed on the Y electrode and negative (−) wall charges are formed on the X electrode X1 of the first group because an address discharge is generated in the first group discharge cell formed by the A electrode receiving the voltage Va and the Y electrode receiving the voltage VscL. In addition, negative (−) wall charges are formed on the A electrode.

During the address period A11, because positive (+) wall charges are formed on the Y electrode that somewhat offset the negative voltage VscL and the voltage of the X electrode X2 of the second group is kept near the reference voltage, the address discharge is not generated in the second group discharge cells.

FIG. 3 shows that the voltage Ve is applied to the X electrode X1 of the first group for both the falling period of the reset period R11 and the address period A11. However, the reference voltage that is equal to the voltage applied to the X electrode X2 of the second group for the same two periods may be applied to the X electrode X1 of the first group instead of the voltage Ve.

In the embodiments shown in FIG. 3, the reset discharge is performed for the second group discharge cell after the address discharge is finished for the first group discharge cell.

During a rising period of a main reset period R12, the voltage at the Y electrode is gradually increased from the reference voltage to a voltage Vs2 while the X electrode X1 of the first group and the A electrode are respectively maintained at a voltage Vs1 and the reference voltage. A voltage Vn which is a negative voltage is applied to the X electrode X2 of the second group. Then, negative (−) wall charges are formed on the Y electrode and positive (+) wall charges are formed on the X electrode X2 of the second group as a weak reset discharge is generated between the Y electrode and the X electrode X2 of the second group while the voltage at the Y electrode is increased. A difference between the voltage Vs2 and the voltage Vn is high enough to generate discharges on the cells receiving these voltages. When the voltages Vs1 and Vs2 applied to the X and Y electrodes for generating the reset voltage during the reset period are both set to be equal to a sustain discharge voltage Vs, the number of power sources required for generating different voltages may be reduced.

During a falling period of the main reset period R12, the voltage at the Y electrode is gradually decreased from the reference voltage to the voltage Vnf while the X electrode X1 of the first group and the X electrode X2 of the second group are respectively maintained at the reference voltage and the voltage Ve. Then, the wall charges formed between the Y and X electrodes are eliminated as the weak reset discharge is generated between the Y electrode and the X electrode X2 of the second group while the voltage at the Y electrode is decreased.

The reset discharge is not generated between the Y electrode and the X electrode X1 of the first group during the main reset period R12 because the X electrode X1 of the first group is biased at the voltage Vs1 when the voltage at the Y electrode is increased to the voltage Vs2 during the rising period. Therefore, a wall charge state after the rising period is substantially equivalent to a wall charge state after the address period. That is, the X electrode X1 of the first group is biased at the reference voltage when the voltage at the Y electrode is reduced to the voltage Vnf during the falling period while positive (+) wall charges are formed on the Y electrode and negative (−) wall charges are formed on the X electrode. In this case, the potential difference between the Y electrode and the X electrode X1 of the first group is reduced, and therefore the reset discharge is not generated between the Y electrode and the X electrode X1 of the first group.

Subsequently, to select a discharge cell during an address period A12, the scan pulse having the voltage VscL is sequentially applied to the Y electrodes, and the Y electrodes not receiving the voltage VscL are biased at the voltage VscH. The voltage VscL is referred to as a scan voltage, and the voltage VscH is referred to as a non-scan voltage. The address pulse having the voltage Va is applied to the A electrode passing through the discharge cell to be selected among the plurality of discharge cells formed by the Y electrodes to which the voltage VscL is applied, and the A electrode which is not selected is biased at the reference voltage. Then, positive (+) wall charges are formed on the Y electrode and negative (−) wall charges are formed on the X electrode X2 of the second group as the address discharge is generated on the discharge cell formed by the Y electrode receiving the voltage VscL and the A electrode receiving the voltage Va. In addition, negative (−) wall charges are formed on the A electrode.

Subsequently, a sustain pulse having the voltage Vs is sequentially applied to the Y electrode and the X electrodes X1 and X2 of the first and second groups for a sustain period S1. Then, a discharge is generated between the Y and X electrodes by the voltage Vs and a wall voltage formed by the address discharge during the address period between the Y and X electrodes. In addition, the voltage Vs is applied to the X electrode X1 of the first group and the reference voltage is applied to the X electrode X2 of the second group when the last sustain pulse of the sustain period S1 is being applied to the Y electrode.

Driving waveforms applied to the even-numbered subfield will now be described.

As shown in FIG. 3, during the sustain period of the odd-numbered subfield preceding the even-numbered subfield, the last sustain discharge is generated between the Y electrode and the X electrode X2 of the second group. This is due to the fact that in the embodiment shown, the last pulses applied during the preceding sustain period include the voltage Vs that is applied to the Y electrode and the reference voltage that is applied to the X electrode X2 of the second group. The last sustain discharge is not generated between the Y electrode and the X electrode X1 of the first group because the voltage at the X electrode X1 of the first group is also biased at the voltage Vs. Alternatively, the last sustain discharge would have been generated between the Y electrode X1 of the first group and the Y electrode if the last sustain pulses included the voltage Vs applied to the X electrode X1 of the first group and the reference voltage applied to the Y electrode.

During a falling period of a reset period R21, the voltage at the Y electrode is gradually decreased to the voltage Vnf after the last sustain pulse that was applied to the Y electrode during the sustain period S1 of the previous subfield. The reference voltage is applied to the A electrode and the X electrode X1 of the first group, and the X electrode X2 of the second group is biased at the voltage Ve. Then, negative (−) wall charges formed on the Y electrode and positive (+) wall charges formed on the A electrode and the X electrode X2 of the second group are eliminated as a weak discharge is generated between the Y electrode and the X electrode X2 of the second group and between the Y electrode and the X electrode while the voltage at the Y electrode is decreased. In this case, as described above regarding the odd-numbered subfield, the reset discharge is not generated between the Y electrode and the X electrode X1 of the first group during the reset period R21. This is due to the fact that the negative (−) wall charges formed on the X electrode X1 of the first group and the positive (+) wall charges formed on the Y electrode after the last sustain discharge of the period S1, tend to counteract and approximately neutralize the potential difference between the Y and X1 electrodes during R21.

To select the discharge cell in an address period A21, the scan pulse having the voltage VscL is sequentially applied to the Y electrodes, and the Y electrodes to which the voltage VscL is not applied are biased at the voltage VscH. In addition, the address voltage having the voltage Va is applied to the A electrode passing through the discharge cell to be selected among the plurality of the discharge cells formed by the Y electrodes to which the voltage VscL is applied. The A electrodes which are not selected are biased at the reference voltage. Positive (+) wall charges are formed on the Y electrode and negative (−) wall charges are formed on the X electrode X2 of the second group as the address discharge is generated in the discharge cell formed by the A electrode receiving the voltage Va and the Y electrode receiving the voltage VscL. In addition, negative (−) wall charges are formed on the A electrode. Because of the positive (+) wall charges formed on the Y electrode, a discharge is not generated in the first group discharge cells during the address period A21.

After the address discharge operation of the address period A21 in the second group discharge cells is complete, a reset discharge is generated in the first group discharge cells during a subsequent reset period R22.

During a rising period of a reset period R22, the voltage at the Y electrode is gradually increased from the reference voltage to the voltage Vs2 while the X electrode X2 of the second group and the A electrode are respectively maintained at the voltage Vs1 and the reference voltage. The voltage Vn which is a negative voltage is applied to the X electrode X1 of the first group. Then, negative (−) wall charges are formed on the Y electrode and positive (+) wall charges are formed on the X electrode X2 of the second group as a weak reset discharge is generated between the Y electrode and the X electrode X1 of the first group while the voltage at the Y electrode is increased.

During a falling period of the reset period R22, the voltage at the Y electrode is gradually decreased from the reference voltage to the voltage Vnf while the X electrodes X1 and X2 of the first and second groups are respectively maintained at the voltage Ve and the reference voltage. Then, the wall charges formed on the Y and X electrodes are eliminated as a weak discharge is generated between the Y electrode and the X electrode X1 of the first group while the voltage at the Y electrode is decreased.

During the second or main reset period R22 of the even-numbered subfield, a reset discharge is not generated between the Y electrode and the X electrode X2 of the second group. The interaction between the existing wall charges and the applied voltages that prevent such a reset discharge are similar to those discussed above in the description of the main reset period R12 of the odd-numbered field.

Subsequently, to select a discharge cell in an address period A22, the scan pulse having the voltage VscL is sequentially applied to the Y electrodes, and the Y electrodes to which the voltage VscL is not applied are biased at the voltage VscH. In addition, the address pulse having the voltage Va is applied to the A electrode passing through the discharge cell to be selected among the plurality of the discharge cells formed by the Y electrode to which the voltage VscL is applied, and the A electrodes which are not selected are biased at the reference voltage. Then, positive (+) wall charges are formed on the Y electrode and negative (−) wall charges are formed on the X electrode X1 of the first group as the address discharge is generated in the discharge cell formed by the A electrode receiving the voltage Va and the Y electrode receiving the voltage VscL. In addition, negative (−) wall charges are formed on the A electrode.

Subsequent to the address period A22, during a sustain period S2, a sustain pulse having the voltage Vs is sequentially applied to the Y electrode and the X electrodes X1 and X2 of the first and second groups. As a result, a discharge is generated by the voltage Vs and a wall voltage formed by the address discharge between the Y and X electrodes during the address period A22.

Accordingly, in the first exemplary embodiment of the present invention, an address discharge may be stably generated because the first group discharge cells are addressed directly after being initialized and the second group discharge cells are addressed directly after being initialized.

The discharge generated by applying the voltage between two electrodes is generated in a predetermined time after the voltage is applied. Therefore, the final voltage Vnf, applied during the reset periods, R11, R12, R21, R22, is maintained for a first time interval Ti during the falling period to form the wall charges for performing the address operation between the Y and X electrodes and between the Y and A electrodes. Charges are formed or eliminated within a gap between the X and Y electrodes because of the discharge generated within the gap when the voltage at the electrode is gradually changed. However, when a strong discharge such as the sustain discharge is generated, the discharge is spread along the electrodes from the gap between the X and Y electrodes. As a result, the charges may be widely formed on the electrodes. These widely formed charges may increase the discharge delay time for the auxiliary reset that is performed after the sustain discharge. Therefore, a considerable portion of the charges formed along the electrodes may remain rather than being eliminated by the reset operation. When considerable amount of charges are remaining on the electrodes, over-discharge or misfiring may be generated during the address period and the sustain period following the reset period. Another exemplary embodiment of the present invention, presents driving waveforms for solving the above problem.

FIG. 4 shows a diagram representing driving waveforms according to a second exemplary embodiment of the present invention for driving a plasma display device.

In the second exemplary driving method, a reset voltage during an auxiliary reset period R11, R21, is maintained at the voltage Vnf for duration of a second time interval T2. The time interval T2 is longer than the time interval T1 that is used for maintaining a reset voltage during a main reset period R12, R22 at the voltage Vnf. Accordingly, a sufficiently long reset discharge may be generated that overcomes the discharge delay by maintaining the Y electrode voltage at the voltage Vnf during the longer second time interval T2. As a result, the wall charges formed on the electrodes by a previous sustain discharge may be eliminated during the auxiliary reset period and over-discharge or misfiring during subsequent address or sustain periods may be prevented.

As described above, the voltage Vs2 applied to the Y electrode during the rising period of the main reset period approaches the voltage Vs, according to both the first and second exemplary embodiments of the present invention. Because the voltage Vn that is lower than the reference voltage is applied to the X electrode, a voltage difference between the Y and X electrodes is increased, and sufficient wall charges may be formed on the Y and X electrodes. However, if the voltage difference between the Y and X electrodes is relatively low, then sufficient wall charges may not be formed on the Y and X electrodes and a sufficient wall voltage may not be established between the Y and X electrodes. Therefore, a subsequent discharge may not be generated. A third exemplary embodiment of the present invention presents driving waveforms for forming a sufficient wall voltage between the Y and X electrodes.

FIG. 5 shows a diagram for representing the driving waveforms according to the third exemplary embodiment of the present invention.

In the third exemplary embodiment, periods A11′ and A21′ are shown that are respectively subsequent to the address periods A11 and A21 that are, in turn, respectively subsequent to the auxiliary reset periods R11 and R21. The periods A11′ and A21′ precede the main reset periods R12 and R22 of each subfield. During the periods A11′ and A21′, the voltage Va is applied to the A electrode and the voltage at the Y electrode is gradually decreased from a voltage VscH2 to the voltage VscL while the X electrodes X1 and X2 of the first and second groups are both biased at the reference voltage. Accordingly, additional negative (−) wall charges are formed on the A electrode and additional positive (+) wall charges are formed on the Y electrode. These additional wall charges cause the potential of the Y electrode to be increased to a level above the applied voltage VscL and the potential of the A electrode to be decreased to a level below the applied voltage Va during the period A11′, A21′. Therefore, a relatively rapid discharge is generated between the Y and A electrodes during the rising period of the subsequent reset period R12, R22. Insertion of the periods A11′ and A21′, in the third embodiment, causes sufficient wall charges to be formed between the Y and A electrodes to generate a faster subsequent reset.

The voltage levels described in the first to third exemplary embodiments of the present invention may be varied from those presented above, provided that voltage differences between the A, X, and Y electrodes are kept similar to those according to the exemplary embodiment of the present invention.

According to the exemplary embodiments of the present invention, a stable address discharge may be generated during the addressing period because each of the first group discharge cells and the second group discharge cells are addressed after being initialized. In other words, including two reset periods within each subfield and addressing half of the discharge cells after one reset period and the other half after the other reset period halves the time required for sequentially addressing all of the cells within each half. Therefore, even the last discharge cells being addressed in each group are not as far from their preceding initialization.

Further, during the auxiliary reset period, by maintaining the Y electrode at a negative voltage for a longer duration, the discharge delay of the auxiliary reset period is overcome and a more effective reset is achieved. The stability of address discharge may be further improved when the voltage difference between the sustain and scan electrodes of the turn-on discharge cell is increased during the address period subsequent to the auxiliary reset.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A driving method for driving a plasma display device, the plasma display device being driven during frames, each frame being divided into a plurality of subfields, the plurality of subfields being divided into a plurality of groups of subfields including a first group of subfields and a second group of subfields, the plasma display device having a plurality of first electrodes, a plurality of second electrodes, and a plurality of third electrodes crossing a common direction of the first electrodes and the second electrodes, the plurality of first electrodes being divided into a plurality of groups of first electrodes including a first group of first electrodes and a second group of first electrodes, the first group of first electrodes passing through first group discharge cells and the second group of first electrodes passing through second group discharge cells, the driving method comprising, during a subfield of the first group of subfields:
initializing the first group discharge cells during a first reset period;
selecting a turn-on discharge cell among the first group discharge cells during a first address period;
initializing the second group discharge cells during a second reset period;
selecting a turn-on discharge cell among the second group discharge cells during a second address period; and
sustain-discharging a selected first group discharge cell and a selected second group discharge cell during a sustain period,
wherein a final voltage applied during the first reset period and a final voltage applied during the second reset period are maintained for different durations of time.

2. The driving method of claim 1,
wherein one of the first reset period and the second reset period is an auxiliary reset period and the other is a main reset period, and
wherein during the auxiliary reset period a voltage at the second electrode is gradually decreased from a first voltage to a second voltage,
wherein during the main reset period the voltage at the second electrode is increased from a third voltage to a fourth voltage and subsequently gradually decreased from a fifth voltage to a sixth voltage.

3. The plasma display device of claim 2,
wherein the second electrode is maintained at the sixth voltage during a first time interval,
wherein the second electrode is maintained at the second voltage during a second time interval, and
wherein the second time interval is longer than the first time interval.

4. The driving method of claim 3, wherein the first reset period is the auxiliary reset period and the second reset period is the main reset period.

5. The driving method of claim 2, further comprising, after a first address period subsequent to the first reset period or after a second address period subsequent to the first reset period:
applying a seventh voltage to the third electrode and gradually decreasing the voltage at the second electrode from an eighth voltage to a ninth voltage,
wherein a difference between the seventh voltage and the ninth voltage is greater than a difference between the second voltage and a voltage applied to the third electrode during the first reset period.

6. The driving method of claim 5,
wherein the seventh voltage is equal to an address voltage applied to the third electrode of the turn-on discharge cell during the first address period and the second address period, and
wherein the ninth voltage is equal to the second voltage.

7. The driving method of claim 2,
wherein the first group of first electrodes and the second group of first electrodes are respectively biased at a tenth voltage and an eleventh voltage while the voltage at the second electrode is being gradually decreased during the first reset period, and
wherein the first group of first electrodes and the second group of first electrodes are respectively biased at a twelfth voltage and a thirteenth voltage while the voltage at the second electrode is being gradually decreased during the second reset period.

8. The driving method of claim 7, wherein a positive voltage is applied to the first group of first electrodes and a negative voltage is applied to the second group of first electrodes while the voltage at the second electrode is being increased to the fourth voltage during the second reset period.

9. The driving method of claim 7, wherein the tenth voltage is equal to the thirteenth voltage, the eleventh voltage is equal to the twelfth voltage, and the tenth voltage is higher than the eleventh voltage.

10. The driving method of claim 2, further comprising, during a subfield of the second group of subfields:
initializing the second group discharge cells during a third reset period;
selecting a turn-on discharge cell among the second group discharge cells during a third address period;
initializing the first group discharge cells during a fourth reset period;
selecting a turn-on discharge cell among the first group discharge cells during a fourth address period; and
sustain-discharging a selected first group discharge cell and a second group discharge cell during the sustain period,
wherein a final voltage applied during the third reset period and a final voltage applied during the fourth reset period are maintained for different durations of time.

11. The driving method of claim 10, wherein one of the third reset period and the fourth reset period is an auxiliary reset period, and the other is a main reset period.

12. The driving method of claim 11, wherein the third reset period is the auxiliary reset period, and the fourth reset period is the main reset period.

13. The driving method of claim 10, wherein one group among the first group of subfields and the second group of subfields includes odd-numbered subfields, and the other group includes even-numbered subfields.

14. The driving method of claim 13, wherein one group of first electrodes among the first group of first electrodes and the second group of first electrodes are odd-numbered first electrodes, and the other group of first electrodes are even-numbered first electrodes.

15. A plasma display device comprising:
a plasma display panel having a plurality of first electrodes, a plurality of second electrodes, and a plurality of third electrodes crossing a common direction of the first electrodes and the second electrodes;
a controller for driving the plurality of first electrodes as a plurality of groups of first electrodes including a first group of first electrodes and a second group of first electrodes, the controller driving the plurality of first electrodes during a frame, the frame including a plurality of subfields having a first group of subfields and a second group of subfields; and
a driving circuit for initializing first group discharge cells corresponding to the first group of first electrodes during a first reset period, address discharging the first group discharge cells during a first address period, initializing second group discharge cells corresponding to the second group of first electrodes during a second reset period, and address discharging the second group discharge cells during a second address period,
wherein the first rest period, the first address period, the second reset period, and the second address period occur during a subfield of the first group of subfields,
wherein the driving circuit applies final voltages during the first reset period and the second reset period such that a time interval for maintaining a final voltage applied during the first reset period is different from a time interval for maintaining a final voltage applied during the second reset period.

16. The plasma display device of claim 15,
wherein one among the first reset period and the second reset period is an auxiliary reset period and the other is a main reset period,
wherein a reset discharge generated during the auxiliary reset period is capable of initializing only a discharge cell having undergone a sustain discharge during a previous subfield, and
wherein a reset discharge generated during the main reset period is capable of initializing all of the discharge cells.

17. The plasma display device of claim 16, wherein a time interval for maintaining the final voltage during the auxiliary reset period is longer than a time interval for maintaining the final voltage during the main reset period.

18. The plasma display device of claim 17, wherein the first reset period is the auxiliary reset period, and the second reset period is the main reset period.

19. The plasma display device of claim 15, wherein, during a subfield of the second group of subfields, the driving circuit initializes the second group discharge cells during a third reset period, address discharges the second group discharge cells during a third address period, initializes the first group discharge cells during a fourth reset period, and address discharges the first group discharge cells during a fourth address period.

20. The plasma display device of claim 19,
wherein one among the third reset period and the fourth reset period is an auxiliary reset period, and the other is a main reset period,
wherein a reset discharge generated during the auxiliary reset period is capable of initializing only a discharge cell having undergone a sustain discharge during a pervious subfield, and
wherein a reset discharge generated during the main reset period is capable of initializing all of the discharge cells.

21. The plasma display device of claim 20, wherein the auxiliary reset period is capable of initializing only a discharge cell having undergone a sustain discharge immediately preceding the auxiliary reset period
